(19) United States
(12) Patent Application Publication
(10) Pub. No.: US 2004/0244612 A1
(43) Pub. Date: Dec. 9, 2004

(54) Method and apparatus for printing viscous material

(75) Inventor: Richard Willshere, Weymouth (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Speedline Technologies, Inc., Franklin, MA

(21) Appl. No.: 10/890,785

(22) Filed: Jul. 14, 2004

Related U.S. Application Data
(63) Continuation-in-part of application No. 10/402,418, filed on Mar. 28, 2003.

(51) Int. Cl. B41F 15/40

(52) U.S. Cl. 101/123; 101/129

(57) ABSTRACT

A method for printing a viscous material on substrates within a stencil printer includes supplying viscous material to a dispensing region of a print head, positioning a first substrate into a print position, printing on the first substrate by means of a pair of blades in contact with a stencil during a first print stroke in which the pair of blades travel in a first direction, the dispensing region being defined between the pair of blades, positioning a second substrate into a print position, and printing on the second substrate during a second print stroke in which the pair of blades travel in a second direction, opposite to the first direction, the pair of blades maintaining contact with the stencil when transitioning between the first and second print strokes. A print head and a stencil printer are further disclosed.

### RELATED APPLICATIONS

This application is a continuation-in-part of U.S. application Ser. No. 10/402,418, entitled PRESSURE CONTROL SYSTEM FOR PRINTING A VISCOUS MATERIAL, filed on Mar. 28, 2003, which is incorporated herein by reference.

### BACKGROUND

In manufacturing a surface-mount printed circuit board, a stencil printer can be used to print solder paste onto the circuit board. Typically, a circuit board having a pattern of pads or some other conductive surface onto which solder paste will be deposited is automatically fed into the stencil printer. One or more small holes or marks (known as “fiducials”) on the circuit board are used to properly align the circuit board with the stencil or screen of the stencil printer prior to printing solder paste or other viscous material onto the circuit board. In some systems, an optical alignment system is used to align the circuit board with the stencil.

Once the circuit board has been properly aligned with the stencil in the printer, the circuit board is raised to the stencil, solder paste is dispensed onto the stencil, and a wiper blade (or squeegee) traverses the stencil to force the solder paste through apertures in the stencil and onto the board. As the squeegee is moved across the stencil, the solder paste tends to roll in front of the blade, which desirably causes mixing and shearing of the solder paste so as to attain a desired viscosity to facilitate filling of the apertures in the screen or stencil. The solder paste typically is dispensed onto the stencil from a standard cartridge such as that manufactured by Systems Engineering and Management Co. (SEMCO), Vista, Calif., USA.

In some stencil printers, any excess solder paste remaining under the squeegee, after it has fully traversed the stencil, remains on the stencil when the squeegee is returned to its initial position for printing on a second circuit board. In some screen printers, a second squeegee moves across the stencil in the direction opposite to that of the first squeegee. The first squeegee and the second squeegee are used on alternating boards to continually pass the roll of solder paste over the apertures of a stencil to print on each successive circuit board. In the stencil printers that utilize two squeegees, there is still the problem that at the end of a manufacturing day, or when the stencil is to be changed, excess solder paste typically remains on the stencil and must be manually removed. Also, in these known printers, it is difficult to maintain a desirable viscosity because volatile solvents escape from the solder paste, thereby affecting the viscosity of the solder paste.

In these stencil printers, the squeegee blades are typically at a predetermined angle with respect to the stencil to apply downward pressure on the solder paste to force the solder paste through the apertures in the stencil as the squeegee is moved across the stencil. The angle of the blade is based on the speed at which the blade traverses the stencil and based on the desired downward pressure on the solder paste from the blade. It is desirable to maintain a consistent pressure on the solder paste as the squeegee traverses the stencil; however, in a typical printer, the pressure varies due to variations in paste viscosity throughout a production run and due to variations in the angle of the squeegee caused by deformation of the squeegee due to the pressure applied by the squeegee driving device.

Responding to some of the problems, noted above, an improved solder-paste print head is described in U.S. Pat. No. 5,947,022, which is incorporated herein by reference in its entirety. This patent describes a movable print head having a cylindrical chamber including ports to which removable cartridges that supply solder paste are coupled. Solder paste is passed from the removable cartridges, into the cylindrical chamber, then out of a dispensing slot, through a stencil and onto a circuit board in a desired pattern.

### SUMMARY

In a first aspect of the invention, a method for printing a viscous material on substrates within a stencil printer comprises: (a) supplying viscous material to a dispensing region of a print head; (b) positioning a first substrate into a print position; (c) printing on the first substrate by means of a pair of blades in contact with a stencil during a first print stroke in which the pair of blades travel in a first direction, the dispensing region being defined between the pair of blades; (d) positioning a second substrate into a print position; and (e) printing on the second substrate during a second print stroke in which the pair of blades travel in a second direction, opposite to the first direction, the pair of blades maintaining contact with the stencil when transitioning between the first and second print strokes.

The viscous material can be solder paste, which is passed through the stencil as the solder paste is discharged from the chamber for selective deposition on the substrate. In another embodiment of the present invention, the first and second substrates can be printed circuit boards. The pair of blades has substantially parallel and substantially planar inner surfaces.

In a further aspect of the invention, the method further comprises: applying force to press the blades against the stencil as the print head passes across the stencil during the first print stroke, thereby bending the blades; as the print head reaches the end of the first print stroke across the stencil, maintaining the print head in engagement with the stencil; and as the print head changes direction and commences the second print stroke across the stencil, maintaining the blades in contact against the stencil, thereby bending the blades in a direction opposite that of the bending in the first print stroke such that a trailing blade functions as a squeegee for the solder paste during each print stroke.

In another aspect of the invention, a print head for printing viscous material on substrates via a stencil comprises a housing defining a chamber, a source port defining a passage having an outlet positioned to allow a viscous material to flow into the chamber, and a pair of downwardly extending, substantially vertical blades defining a dispensing region that provides an outlet from which the viscous material can flow out of the chamber. The pair of blades engages the stencil, and are fabricated out of resilient material so that upon transitioning between a first print stroke to print on a first substrate and a second print stroke to print on a second substrate, the pair of blades maintain engagement with the stencil.

Each blade includes a polymeric material selected from the group consisting of polyurethane, latex and silicone. The blades have inner surfaces that are substantially planar and parallel to one another. Each blade comprises a resilient portion and a metal portion fixedly held by the resilient portion.

In yet another aspect of the invention, a stencil printer for printing viscous material on a substrate comprises a frame, a stencil coupled to the frame, and a print head coupled to the frame. The print head has a housing defining a chamber, a source port defining a passage having an outlet positioned to allow a viscous material to flow into the chamber, and a pair of downwardly extending, substantially vertical blades defining a dispensing region that provides an outlet from which the viscous material can flow out of the chamber. A controller is coupled with the housing and the source port of the print head in which the controller causes the delivery of viscous material to and the movement of the pair of blades between a first print stroke in which the pair of blades travel in a first direction to print on a first substrate and a second print stroke in which the pair of blades travel in a second direction, opposite the first direction, to print on a second substrate. The pair of blades are fabricated out of resilient material so that upon transitioning from the first print stroke to the second print stroke, the pair of blades maintain engagement with the stencil.

In another aspect of the invention, a stencil printer for printing viscous material on a substrate comprises a frame, a stencil coupled to the frame, and a print head coupled to the frame for printing viscous material on the stencil. The print head comprises a dispensing region that provides an outlet from which the viscous material is dispensed onto the stencil. Further provided are means for maintaining the print head in contact with the stencil when moving the blade means between a first print stroke in which the print head travels in a first direction to print on a first substrate and a second print stroke in which the print head travels in a second direction, opposite the first direction thereby substantially maintaining the viscous material within the dispensing region.

The print head further comprises means for engaging the stencil, which comprises a pair of downwardly extending, substantially vertical blades fabricated out of resilient material.

### BRIEF DESCRIPTION OF THE DRAWINGS

In the accompanying drawings, described below, like reference characters refer to the same or similar parts throughout the different views. The drawings are not necessarily to scale, emphasis instead being placed upon illustrating particular principles of the methods and apparatus characterized in the Detailed Description.

FIG. 1 is a front elevational view of a stencil printer in which an embodiment of the present invention is implemented;

FIG. 2 is a perspective view of a print head of the present invention;

FIG. 3 is a schematic view of the print head illustrated in FIG. 2;

FIG. 4 is a partial sectional view taken along line 4-4 in FIG. 2;

FIG. 5 is a perspective view of a removable insert of the present invention;

FIG. 6 is a partial end view of the insert illustrated in FIG. 5;

FIG. 7 is a partial end view of an insert of another preferred embodiment;

FIG. 8A is a schematic view of a prior art print head moving in a first print stroke;

FIG. 8B is a schematic view of the prior art print head illustrated in FIG. 8A moving in a second print stroke;

FIG. 9A is a schematic view of the print head of the present invention moving in a first print stroke; and

FIG. 9B is a schematic view of the print head illustrated in FIG. 9A moving in a second print stroke.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

For purposes of illustration, embodiments of the present invention are described below, with reference to a stencil printer used to print solder paste onto a circuit board. One skilled in the art will appreciate, however, that the use of the apparatus described herein is not limited to stencil printers that print solder paste onto circuit boards, but rather, may be used in other applications requiring dispensing of other viscous materials such as glues and encapsulants on a variety of substrates. For example, the apparatus may be used to print epoxy for use as underfill for chip-scale packages (typically having a substrate contact surface with an area of about 1 cm²).

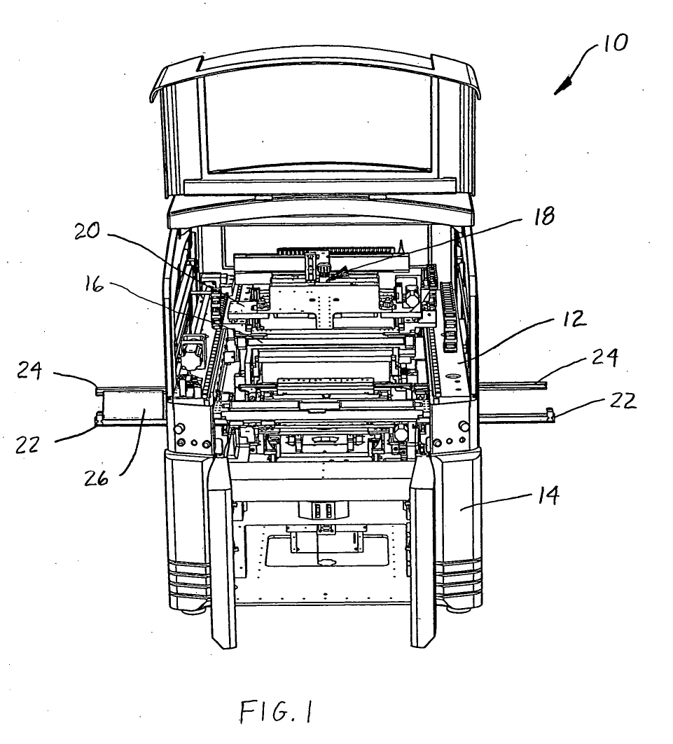

FIG. 1 shows a stencil printer, generally indicated at 10, in accordance with the present invention. The stencil printer 10 includes a frame 12 that supports components of the stencil printer 10 including a controller 14, a stencil 16 coupled to the frame, and a dispensing or print head, generally indicated at 18, from which solder paste may be dispensed. The print head 18 is coupled to a carriage 20, which is coupled to the frame 12 of the stencil printer 10. The carriage 20 is capable of moving the print head in a linear direction across the stencil as well as in a z-direction toward and away from the stencil by, for example, a pneumatic actuator. The carriage 20 is moved by motors under the control of the controller 14. The controller 14 is implemented using a personal computer having a Microsoft DOS or Windows NT operating system with application specific software to control the operation of the stencil printer 10. The movement of the carriage 20 allows the print head 18 to be placed over the stencil 16 and moved across the stencil 16 to allow printing of viscous material onto a substrate.

Stencil printer 10 also includes a conveyor system having rails 22, 24 for transporting a substrate, e.g., a circuit board 26, to a printing position in the stencil printer 10. The stencil printer 10 has a number of pins positioned beneath the circuit board 26 when the circuit board is in the dispensing position. The pins are used to raise the circuit board 26 off of the rails to place the circuit board in contact with, or in close proximity to, the stencil 16 when printing is to occur.

Print heads 18 in accordance with embodiments of the invention can be used in stencil printers, such as the ULTRAPRINT 3000 stencil printer and the AP Series stencil printer (both available from Speedline Technologies, Inc. of Franklin, Mass., USA).

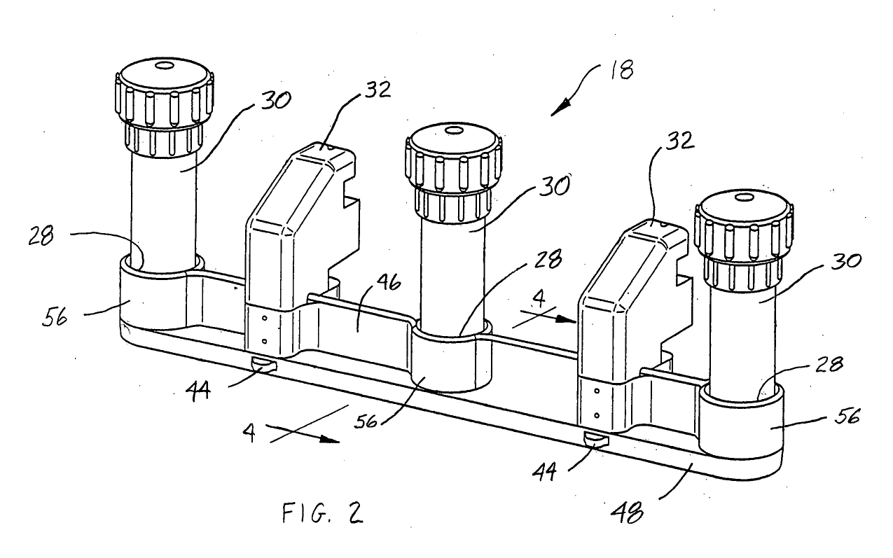

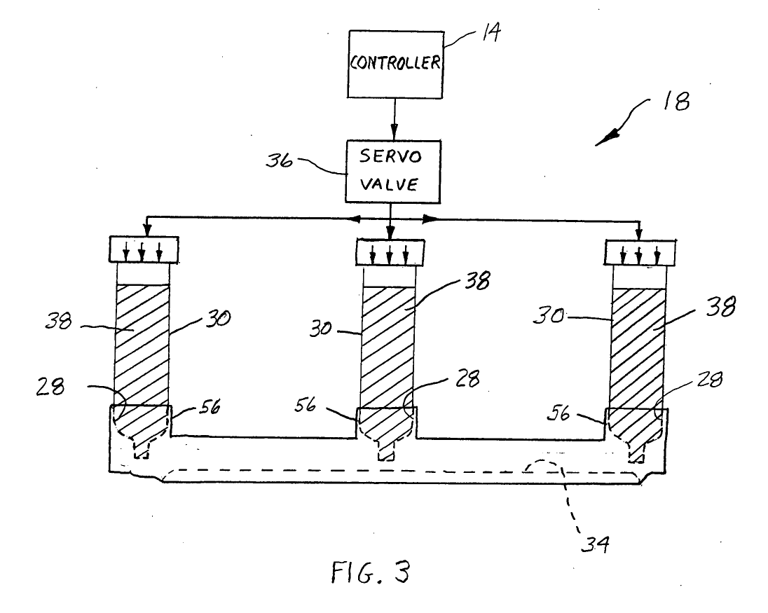

In the embodiment illustrated in FIGS. 2 and 3, the print head 18 includes three source ports 28 configured to receive standard three-ounce or six-ounce solder paste cartridges 30 that provide viscous material, e.g., solder paste, to the print head 18 during a printing operation. The cartridges 30 are available from Systems Engineering & Management Co. (SEMCO) of Vista, Calif., USA. The top of each cartridge 30 is designed to be coupled to one end of a pneumatic air hose (not shown, but schematically illustrated in FIG. 3) with the other end of the hose being coupled with an air compressor (not shown) that forces solder paste from the cartridge into the print head. As is readily understood by those skilled in the art, the print head 18 can be adapted to receive other standard, or non-standard, cartridges or other sources of solder paste. A mechanical device, such as a piston, may be used in addition to, or in place of, air pressure to force the solder paste from the cartridges 30 into the print head 18.

A pair of attachment brackets each designated 32, are provided for attaching the print head 18 to the frame 12 of the stencil printer 10. The arrangement is such that the print head 18 is movable across the stencil 16 between a first print stroke in which the print head travels across the stencil 16 in a first linear direction to print on a circuit board 26 and a second print stroke in which the print head travels across the stencil in a second direction, opposite the first, to print on a subsequent circuit board that is delivered to the stencil printer 10 after the prior circuit board is printed upon. Each print stroke results in a print operation being performed on a single printed circuit board 26.

Any number of source ports 28 can be provided on the print head 18 to couple more or fewer cartridges 30 with the print head, with the three cartridges shown in FIGS. 2 and 3 for illustration purposes only. The number of cartridges 30 is selected based on the length of the print head 18 and the capacity of the cartridge used. The length of the print head 18 is determined, in part, based on the width of the circuit boards to be printed upon. If the size of the circuit board changes, the print head 18 may be replaced by a new print head having a length sized for the new circuit board. The effective length of a dispensing slot 34, shown by broken lines in FIG. 3, may also be reduced to accommodate smaller circuit boards by partially covering a portion of the slot. In particular embodiments, the dispensing slot 34 is about 20 cm to about 60 cm (8-24 inches) in length, and the cartridges 30 are mounted 20 cm apart.

The print head 18 coupled with a control system is illustrated in FIG. 3. The control system includes the controller 14 including a computer-readable storage medium coupled with a processor for executing software code stored on the storage medium. The controller 14, among other things, controls the operation of the print head 18 to move the print head between its first and second positions, as well as to deliver circuit boards to the print position. The controller 14 is also in communication with a cartridge gas pressure servo valve 36, which is coupled with a compressed gas source. The controller 14 sends instructions to the servo valve 36 to regulate the dispensing of viscous material, e.g., solder paste 38, through the dispensing slot 34. The controller 14 may also be in communication with one or more sensors (not shown) for measuring the pressure or amount of solder paste in the print head 18, which provides a feedback mechanism for the control system. The sensors relay the feedback to the controller 14, which sends instructions to the servo valve 36 to control the flow of compressed gas to increase or decrease the flow of solder paste 38.

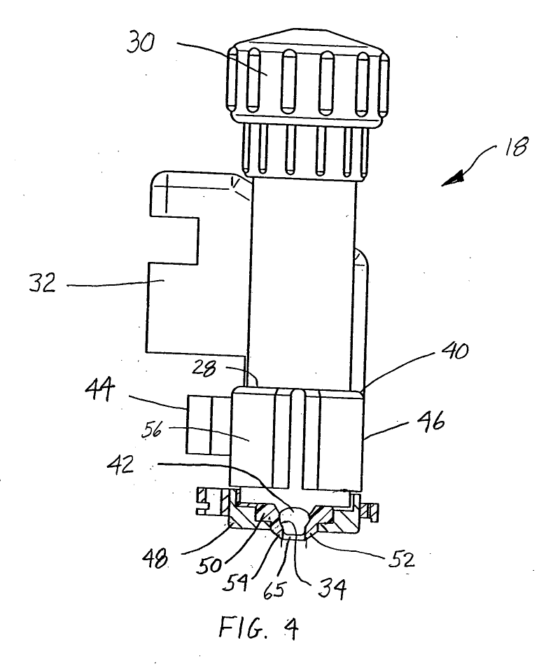

Turning now to FIG. 4, the print head 18 includes a housing 40 having a chamber that defines a dispensing region 42, which in turn opens into the dispensing slot 34. In particular embodiments, as mentioned above, the dispensing region 42 has a length of 20-60 cm and a diameter/width of about 1 cm. The housing 40 includes a suitable fastening mechanism 44, such as a complementary hinge and latch arrangement, which allows two members, which form the top and bottom portions 46, 48 of the housing, to be broken apart or swung open to receive an insert 50 comprising a pair of downwardly extending, substantially vertical blades 52, 54, which together function in a manner similar to the “squeegee” referred to above. The insert 50 can be removed from the housing 40 of the print head 18 when the fastening mechanism 44 is released to decouple the top and bottom housing portions 46, 48. The source ports 28 are positioned on the top portion 46, and the housing 40 includes collars 56 that secure the cartridges 30 in place and define passages through which the solder paste 38 flows from the cartridges 30 to the dispensing region 42. The insert 50 is clamped in place between the top and bottom housing portions 46, 48 when the two portions are secured together by the fastening mechanism 44.

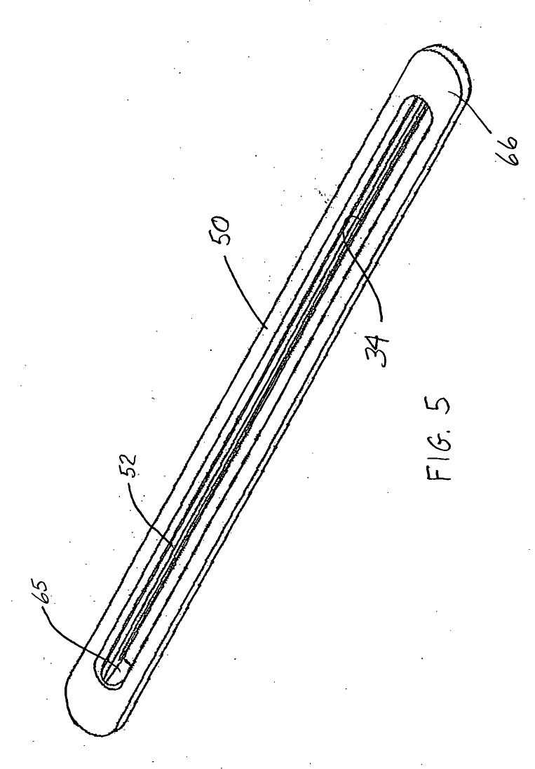

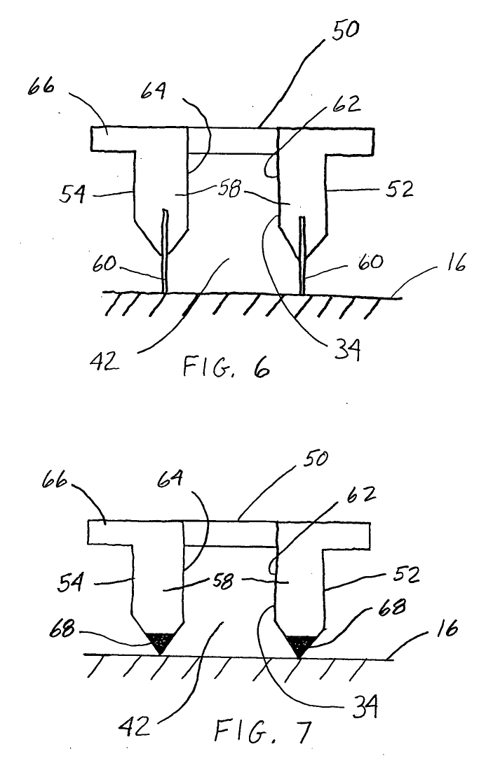

Referring to FIGS. 5 and 6, and more particularly to FIG. 6, each blade 52, 54 of the removable insert 50 includes a resilient body portion 58 and a metal portion 60. The blades 52, 54 channel the viscous material onto the stencil 16 passing beneath the dispensing region 42 and slot 34, which as shown is defined by the blades. Each of the blades 52, 54 has a length approximately equal to the length of the dispensing slot 34. The blades 52, 54 also have inner, facing surfaces 62, 64 that are substantially planar and parallel to each other. The blades 52, 54 can be part of the insert 50 or be provided separately and suitably secured to the insert. The metal portion 60 of each blade 52, 54 can be formed of thin sheets of metal (e.g., spring steel) having a thickness of about 0.1 to about 0.25 mm (0.004 to 0.010 inches) and oriented parallel to one another. The metal portion 60 is embedded in the resilient portion 58 by pre-positioning the metal portion in a mold and casting the resilient portion around it. The insert 50 includes end dams 65 formed on the insert 50 to maintain a seal between the dispensing region 42 and atmosphere. Each of the end dams 65 couples to each of the blades 52, 54 so that a 360° seal between the stencil 16 and the print head 18 can be maintained.

Preferably, the resilient body portion 58 of each blade 52, 54 and the remainder of the insert 50 is fabricated from a deformable material, typically a polymer, such as polyurethane, latex or silicon, having a durometer of about 50-70 Shore. The top, laterally extending portion 66 of the insert 50 forms a frame that can be clamped between the print head portions 46, 48.

FIG. 7 illustrates an alternate embodiment in which tips 68 of the blades 52, 54 are fabricated from hard material and may be formed of a high-durometric polymeric material, such as polyurethane, which can be molded with comparatively lower-durometric polymeric material (e.g., polyurethane) for the remainder of the insert 50 by pouring sufficient high-durometric polymeric material into a mold wherein the high-durometric polymeric material flows or settles down to the lower regions of the mold that shapes the tips. The lower-durometric polymeric material is then poured over the high-durometric polymeric material to fill the remainder of the mold to form the insert 50. The combination of lower and higher durometric polymeric materials provide a highly desirable degree of flexibility, wear resistance and sealing against the stencil 16 during printing.

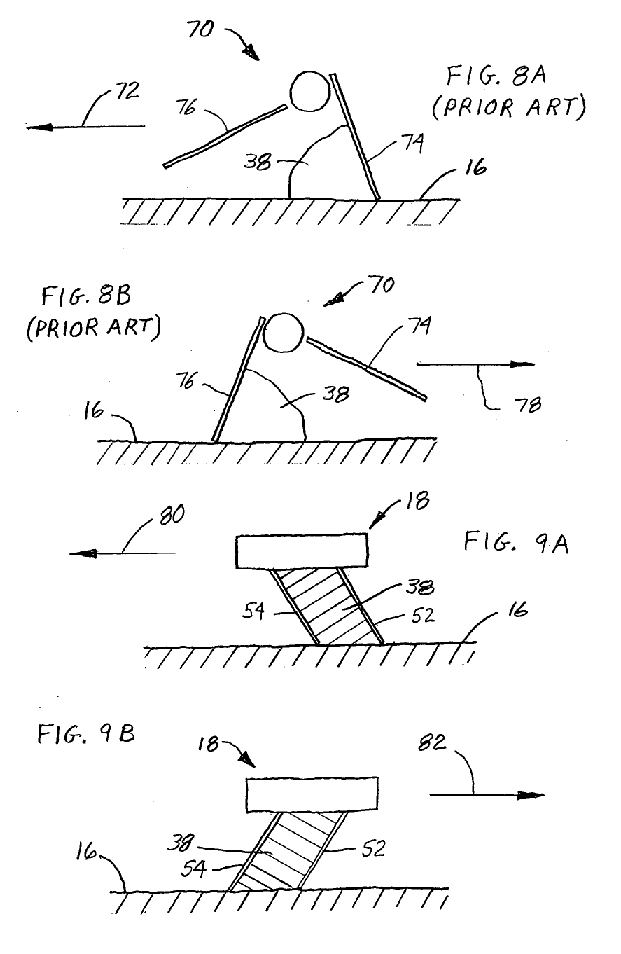

FIGS. 8A and 8B illustrate in schematic form the operation of a prior art print head, generally indicated at 70. Specifically, as shown in FIG. 8A, when traveling in a first print stroke, indicated by arrow 72, blade 74 functions as the trailing blade to move solder paste 38 over the stencil 16. The other blade 76 is lifted off of the stencil 16 by rotating the print head 70 clockwise. Referring to FIG. 8B, upon reversing direction of the print head 70 to achieve a second print stroke, indicated by arrow 78, the print head 70 is rotated counterclockwise so that blade 76 functions as the trailing blade that moves the solder paste 38 over the stencil 16 and blade 74 is lifted off of the stencil. This results in the solder paste being exposed to atmosphere during the entire print stroke.

With the blade configuration used in at least some embodiments of the invention, when the print head 18 is in the lowered printing position so that it is in contact with the stencil 16, the stencil printer 10 operates by feeding solder paste 38 from the cartridge 30 into the dispensing region 42. With the dispensing region 42 filled with solder paste 38, the solder paste then flows onto a stencil 16 positioned over a substrate, such as the printed circuit board 26, with the solder paste flowing through apertures in the stencil onto the printed circuit board in a pre-defined pattern. In the printing position, the blades 52, 54 contact the top surface of the stencil 16. For each direction that the print head 18 moves across the stencil 16, one of the two blades 52 or 54, which are oriented parallel to each other, will be a trailing blade and will scrape any excess solder paste 38 off the stencil. This motion also rolls the solder paste 38, thereby causing the desirable mixing and shearing of the solder paste so as to attain the preferred viscosity.

This operation is schematically depicted in FIGS. 9A and 9B, where the blades 52, 54 maintain a parallel relationship with one another. FIG. 9A illustrates the print head 18 traveling in the first print stroke, indicated by arrow 80. As shown, the space between the blades 52, 54 is completely filled with solder paste 38, which produces a more effective print operation without having to pressurize the dispensing region 42 beyond the pressure offered by cartridges 30. The resilient nature of the blades 52, 54, i.e., the resilient body portions 58, enables the blades to cant in the manner depicted in FIGS. 9A and 9B. It should also be understood that the metal portion 60 of each blade 52, 54 is capable of flexing a slight amount even though each blade is represented as being rigid in FIGS. 9A and 9B. The slant of the blades 52, 54 can be increased or decreased with respect to a vertical plane by increasing or decreasing the pressure applied by the print head 18 on the stencil 16, respectively.

Between the two blades 52, 54, the solder paste 38 is deposited by the cartridges 30. However, it should be understood that the provision of cartridges 30 may be replaced by a solder paste source in fluid communication with the print head 18 or by manually depositing solder paste within the print head. To prevent breaking the seal formed at the interface of the blades 52, 54 (and end dams 65) and the stencil 16, a consistent force is applied to the print head to press it against the stencil. The force can be applied via the pneumatic actuator, for example. As the trailing blade 52 or 54 is pressed against the stencil 16, the blade bends to function as a squeegee, with the metal portion 60 of the blade trailing its neutral position (relative to the resilient body portion of the blade) when the blade is passing across the stencil. The displacement of the blades 52, 54 is opposite the direction of the print head 18 travel. Depending on the durometer of the polymeric material that is used, as well as the pressure being applied by the print head 18, the slant and bend of the blades 52, 54 during the print stroke may be adjusted and controlled.

When transitioning from the first print stroke in which a printing operation is applied to a “first” circuit board 26 to the second print stroke in which a printing operation is applied to a “second” circuit board, the print head 18 need only be slightly raised to effect the “flipping” of the blades 52, 54 so that they are canted in the manner shown in FIG. 9B. At the end of a stroke across the stencil 16 by the print head 18, the blade 52 or 54 that was previously the trailing blade becomes the leading blade as the print head is passed back across the stencil in the opposite direction. The ends of the blades 52, 54 that engage the stencil 16 are allowed to flip over to the new trailing sides of the blades by slightly raising the print head 18 at the end of a pass to allow the blades to return to a neutral, centered orientation. As the print head 18 begins moving across the stencil 16 in the opposite direction, the print head is again slightly lowered (via, e.g., the pneumatic actuator) to press it against the stencil, thereby causing the blades 52, 54 to bend back, displacing the ends in the direction of the new trailing sides of the blades.

It should be understood that the pressure on the blades 52, 54 is substantially maintained between the first print stroke and the second print stroke. Notwithstanding the slight raising of the print head 18, the resilient nature of the body portions 58 of the blades 52, 54 enables the application of a consistent pressure of the blades on the stencil 16, thereby maintaining the seal between the print head and the stencil 16. This is important since the solder paste 38 within the dispensing region 42 is not pressurized by a secondary source beyond the pressure provided by the cartridges 30. Thus, the seal between the blades 52, 54, end dams 65 and the stencil 16 is maintained.

In other embodiments, viscous materials other than solder paste are printed using the apparatus and methods described above. In one embodiment, liquid epoxy is printed from the print head. Liquid epoxy can be used as an underfill for chip-scale packages, where the epoxy is deposited onto an area about 1 cm² on a printed circuit board, and the chip is then mounted onto the epoxy.

While this invention has been shown and described with references to particular embodiments thereof, those skilled in the art will understand that various changes in form and details may be made therein without departing from the scope of the invention, which is limited only by the following claims.

What is claimed is:

1. A method for printing a viscous material on substrates within a stencil printer, the method comprising:
supplying viscous material to a dispensing region of a print head;
positioning a first substrate into a print position;
printing on the first substrate by means of a pair of blades in contact with a stencil during a first print stroke in which the pair of blades travel in a first direction, the dispensing region being defined between the pair of blades;
positioning a second substrate into a print position; and
printing on the second substrate during a second print stroke in which the pair of blades travel in a second direction, opposite to the first direction, the pair of blades maintaining contact with the stencil when transitioning between the first and second print strokes.

2. The method of claim 1, wherein the viscous material is solder paste.

3. The method of claim 2, further comprising passing the solder paste through the stencil as the solder paste is discharged from the chamber for selective deposition on the substrate.

4. The method of claim 3, wherein the first and second substrates are printed circuit boards.

5. The method of claim 3, wherein the pair of blades has substantially parallel and substantially planar inner surfaces.

6. The method of claim 5, further comprising:
applying force to press the blades against the stencil as the print head passes across the stencil during the first print stroke, thereby bending the blades;
as the print head reaches the end of the first print stroke across the stencil, maintaining the print head in engagement with the stencil; and
as the print head changes direction and commences the second print stroke across the stencil, maintaining the blades in contact against the stencil, thereby bending the blades in a direction opposite that of the bending in the first print stroke such that a trailing blade functions as a squeegee for the solder paste during each print stroke.

7. A print head for printing viscous material on substrates via a stencil, the print head comprising:
a housing defining a chamber;
a source port defining a passage having an outlet positioned to allow a viscous material to flow into the chamber; and
a pair of downwardly extending, substantially vertical blades defining a dispensing region that provides an outlet from which the viscous material can flow out of the chamber, the pair of blades engaging the stencil;
wherein the pair of blades are fabricated out of resilient material so that upon transitioning between a first print stroke to print on a first substrate and a second print stroke to print on a second substrate, the pair of blades maintain engagement with the stencil.

8. The apparatus of claim 7, wherein each blade includes a polymeric material.

9. The apparatus of claim 8, wherein the polymeric material is selected from the group consisting of polyurethane, latex and silicone.

10. The apparatus of claim 7, wherein the blades have inner surfaces that are substantially planar and parallel to one another.

11. The apparatus of claim 7, wherein each blade comprises a resilient portion and a metal portion fixedly held by the resilient portion.

12. The apparatus of claim 7, wherein the viscous material is solder paste.

13. A stencil printer for printing viscous material on a substrate, the stencil printer
comprising:
a frame;
a stencil coupled to the frame;
a print head coupled to the frame, the print head having
a housing defining a chamber,
a source port defining a passage having an outlet positioned to allow a viscous material to flow into the chamber, and
a pair of downwardly extending, substantially vertical blades defining a dispensing region that provides an outlet from which the viscous material can flow out of the chamber; and
a controller coupled with the housing and the source port of the print head, the controller causing the delivery of viscous material to and the movement of the pair of blades between a first print stroke in which the pair of blades travel in a first direction to print on a first substrate and a second print stroke in which the pair of blades travel in a second direction, opposite the first direction, to print on a second substrate;
wherein the pair of blades are fabricated out of resilient material so that upon transitioning from the first print stroke to the second print stroke, the pair of blades maintain engagement with the stencil.

14. The stencil printer of claim 13, wherein each blade includes a polymeric material.

15. The stencil printer of claim 14, wherein the polymeric material is selected from the group consisting of polyurethane, latex and silicone.

16. The stencil printer of claim 13, wherein the blades have inner surfaces that are substantially planar and parallel to one another.

17. The stencil printer of claim 13, wherein each blade comprises a resilient portion and a metal portion fixedly held by the resilient portion.

18. The stencil printer of claim 13, wherein the viscous material is solder paste.

19. A stencil printer for printing viscous material on a substrate, the stencil printer comprising:
a frame;
a stencil coupled to the frame;
a print head coupled to the frame for printing viscous material on the stencil, the print head comprising a dispensing region that provides an outlet from which the viscous material is dispensed onto the stencil; and
means for maintaining the print head in contact with the stencil when moving the blade means between a first print stroke in which the print head travels in a first direction to print on a first substrate and a second print stroke in which the print head travels in a second direction, opposite the first direction thereby substantially maintaining the viscous material within the dispensing region.

20. The stencil printer of claim 19, wherein the print head comprises means for engaging the stencil.

21. The stencil printer of claim 20, wherein the means for engaging the stencil comprises a pair of downwardly extending, substantially vertical blades.

22. The stencil printer of claim 21, wherein the pair of blades are fabricated out of resilient material.
